(19) United States
(12) Patent Application Publication
(10) Pub. No.: US 2025/0091397 A1
(43) Pub. Date: Mar. 20, 2025

(54) TOW HOOK FOR A VEHICLE

(71) Applicant: FCA US LLC, Auburn Hills, MI (US)

(72) Inventors: Ravishankar Pattan, Troy, MI (US); Hassan El-Hor, Ann Arbor, MI (US); Chris Kennedy, Rochester Hills, MI (US); Charles Buttler, Linden, MI (US)

(21) Appl. No.: 18/469,834

(22) Filed: Sep. 19, 2023

(51) Int. Cl. B60D 1/52; B60D 1/04

(52) U.S. Cl. CPC B60D 1/52; B60D 1/04

(57) ABSTRACT

A tow hook assembly for a motor vehicle includes a mounting bracket and a tow hook having a towing end and a mounting end. The towing end has a towing direction. The mounting end extends through the mounting bracket in a direction forming an angle not coincident with the towing direction. A fastener attaches to the mounting end of the tow hook and is configured to resist movement of the tow hook relative to the mounting bracket in a towing direction and allow movement of the tow hook in a direction opposite to the towing direction. A support bracket has a first end positioned adjacent to the towing end of the tow hook configured to support the towing end of the tow hook. The support bracket has a second end having a first portion having an aperture therethrough. The mounting end extends through the aperture.

### FIELD

The present disclosure relates to tow hooks for vehicles and, more particularly, to a tow hook that prevents damage to vehicle components upon an impact.

### BACKGROUND

This section provides background information related to the present disclosure which is not necessarily prior art.

Motor vehicles, and particularly trucks, are known to have one or more tow hooks mounted to a front end or rear end thereof. These tow hooks provide a convenient attachment point for a rope, strap or cable when the motor vehicle is being towed or pulled, is being secured from movement during shipping, or when the motor vehicle is pulling from its front end or rear end.

Motor vehicles, including trucks, are also required to have supplemental restraint systems, such as air bags, installed for occupant safety. These supplemental restraint systems are generally intended to activate at the command of a control system that detects a frontal impact of a specified severity. It is not desirable for the air bag to activate without such an impact occurring. The motor vehicle is also built with a front bumper system that is adapted to readily absorb, in a planned and prescribed fashion, frontal impacts of lesser severity without activating the air bag. A tow hook assembly that is rigidly mounted to a front bumper of the vehicle presents additional challenges to designing for these desirable response characteristics, as the tow hook might protrude from the face of the bumper, and thereby become the initial point of contact during an impact.

Due to the location and nature of such prior art tow hooks, a motor vehicle provided with both an airbag system and tow hooks has often required adjustment of the airbag system to accommodate the effect of the tow hook(s) to meet desired airbag deployment requirements during low-speed impact events. Consequently, it is desirable to provide tow hooks on an automobile that will perform their intended towing function but will not affect the operation of the airbag system.

### SUMMARY

This section provides a general summary of the disclosure and is not a comprehensive disclosure of its full scope or all of its features.

In one aspect of the disclosure, a tow hook assembly for a motor vehicle includes a mounting bracket and a tow hook having a towing end and a mounting end. The towing end has a towing direction. The mounting end extends through the mounting bracket in a direction forming an angle not coincident with the towing direction. A fastener attaches to the mounting end of the tow hook and is configured to resist movement of the tow hook relative to the mounting bracket in a towing direction and allow movement of the tow hook in a direction opposite to the towing direction. A support bracket has a first end positioned adjacent to the towing end of the tow hook configured to support the towing end of the tow hook. The support bracket has a second end having a first portion having an aperture therethrough. The mounting end extends through the aperture.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations and are not intended to limit the scope of the present disclosure.

FIG. 1 is a block diagrammatic view of a vehicle having tow hook assemblies according to the present disclosure.

FIG. 2 is an underside view of the mounting for a tow hook.

FIG. 3 is a side view of the mounting for the tow hook.

Corresponding reference numerals indicate corresponding parts throughout the several views of the drawings.

### DETAILED DESCRIPTION

Example embodiments will now be described more fully with reference to the accompanying drawings.

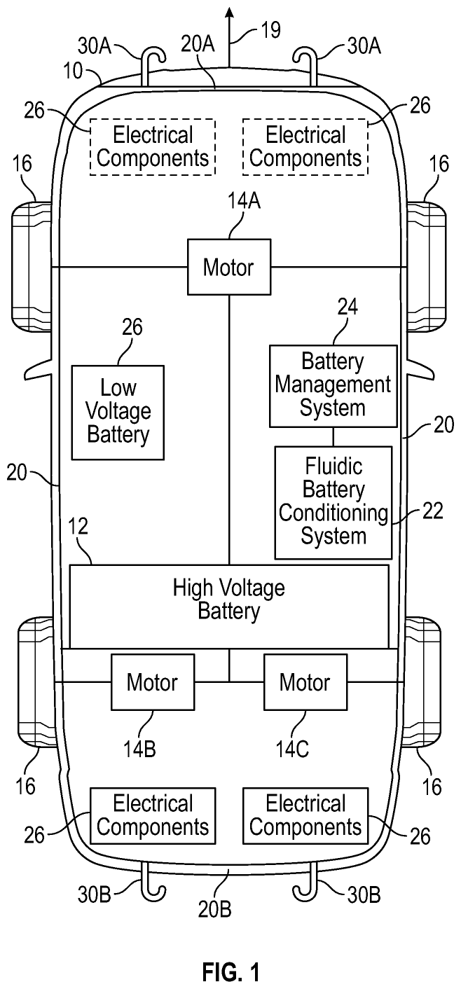

Referring now to FIG. 1, a schematic block diagram of a vehicle 10 is illustrated. The vehicle 10 is adapted to include various features not illustrated, such as a passenger compartment mounted thereon.

In this example, the vehicle 10 is an electric vehicle that has a high voltage battery 12 that is used to power one or more electric motors 14A, 14B and 14C. The electric motors 14A, 14C, 14C are used to provide motive force to the vehicle wheels 16. The number of motors 14 within the electric vehicle 10 may vary. Each of the wheels 16 may have their own motor associated therewith. As shown in the rear of the vehicle 10, each wheel has an electric motor 14B, 14C. One motor 14A is used to power the wheels at one end of the vehicle. The motors 14B and 14C power individual wheels 16.

The high voltage battery 12 may be coupled to a support structure 18, a portion of which is illustrated. The support structure 18 may be a traditional ladder type frame or portions of a unibody construction such as a sill member. The members of the support structure 18 illustrated run parallel to a longitudinal axis 19 of the vehicle 10. The terms longitudinal and lateral used to describe the positions of components in the vehicle 10 relative to the longitudinal axis 19. Further inboard refers to components positions toward the center or longitudinal axis 19 of the vehicle. The longitudinal support members 18 are used to support lateral support members 20. The lateral support members 20 are bumper supports in this example.

A fluidic battery conditioning system 22 may be used for controlling the temperature and pressure within the high voltage battery 12. A battery management system 24, in communication with the fluidic battery conditioning system 22 and any sensors associated with the high voltage battery 12, is used to control the operation of the fluidic battery conditioning system 22 as described in more detail below. The battery management system 22 is a microprocessor-based controller programmed to perform various steps used in the operation of the system.

The vehicle 10 also includes a low voltage battery 24 that has a voltage less than the high voltage battery 12. Examples for the low voltage battery 24 include but are not limited to a 12 volt or 48 volt battery. An example of a high voltage battery 12 is 400 volts plus or minus 50 volts.

The vehicle 10 may have various electrical components 26 disposed therein. In this example, the electrical components are located near each corner of the vehicle 10. The electrical components 26 include but are not limited to a battery module, motor, electric climate control components, and battery module cooling components.

The lateral supports 20 may extend between the longitudinal support members 18 and are supported thereby. The lateral supports 20 may have one or more tow hook assemblies 30 coupled thereto. In the present example, front tow hook assemblies 30A are disposed at each side of the lateral support 20. Tow hook assemblies 30B are rear tow hooks and are supported by the lateral support 20. The tow hook assemblies 30A may all be configured as described below. However, only one of the tow hooks may be configured in the present manner.

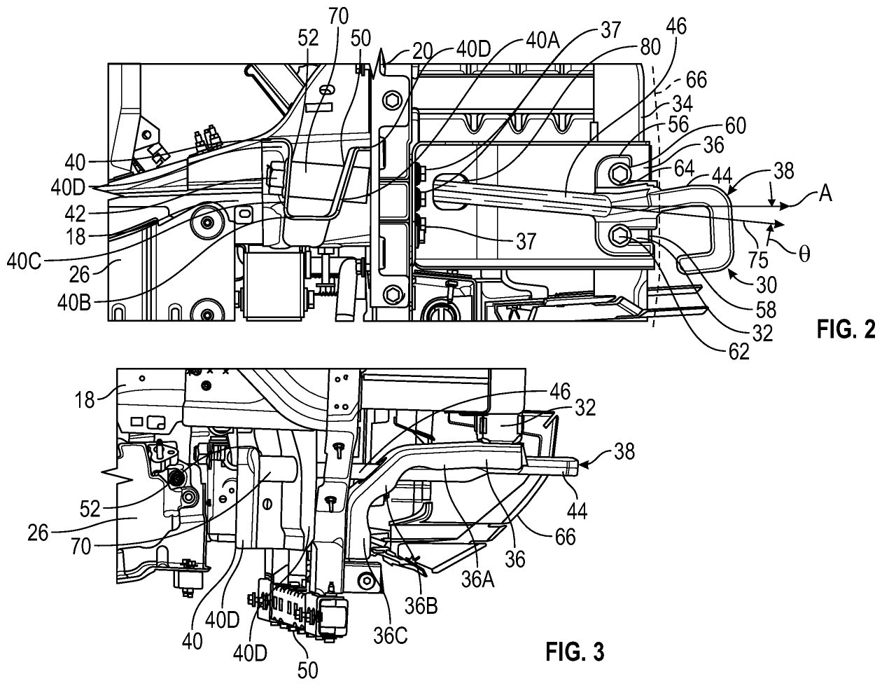

As a point of clarity, FIGS. 2 and 3 are views from the underside of the motor vehicle 10 and the side of the vehicle 10 to which the tow hook assembly 30 is attached, as the preferred mounting configuration is on the bottom of the motor vehicle's frame rail such as the longitudinal support members 18 or the lateral supports 20. It is contemplated, however, that the tow hook assembly 30 may be adapted for mounting on the top of the frame rail. In this example, a mounting block 32 is disposed between the lateral support 20 and the tow hook assembly 30.

Referring now to the drawings, FIGS. 2-3 illustrate an embodiment of a tow hook assembly 30 according to the invention. The tow hook assembly 30 is shown as being adapted for mounting between lateral support 20 and an impact beam 34 of the vehicle 10. As described below, each tow hook assembly 30 is attached between the lateral support 20 and impact beam 34 of the motor vehicle such that the motor vehicle may be towed by the tow hook assembly 30 and such that the tow hook assembly 30 will break away from the motor vehicle upon application of a force which is less than a force required to activate an airbag.

The tow hook assembly 30 includes a mounting bracket 36, a tow hook 38, a support bracket 40 and a fastener 42. The mounting bracket 36 is attached to the lateral support 20 of the motor vehicle using fasteners 37 such as bolts as shown in FIGS. 2-3. The support bracket 40 is preferably welded to the longitudinal support 18 impact beam 4 of the motor vehicle. It will be readily apparent that the mounting bracket 36 and/or the support bracket 40 can be attached to the appropriate portions of the motor vehicle with bolts, welding, or any other means known in the art. It will also be readily apparent that, depending on the particular design of the motor vehicle, both the mounting bracket and the support bracket could be attached to the frame rail.

The tow hook 38 includes a towing end 44 and a mounting end 46. The towing end 44 is adapted to be engaged by a tow rope, strap or cable so that the motor vehicle may be towed thereby. As shown in FIG. 2, the towing end 44 of the tow hook 38 is preferably configured as an open loop hook. Other towing end shapes can be utilized, such as a closed loop, or an upward or downward facing hook.

During assembly, the tow hook 38 is positioned so that the towing end 44 is generally aligned along a towing direction (indicated by arrow A in FIG. 2), and the mounting end 46 is disposed at angle θ relative to and not the same or coincident with the towing direction as indicated by arrow 75. In one example, the angle θ was between about 3 degrees and about 6 degrees. More specifically, an angle of 5 degrees was used. The mounting end 46 passed through an aperture 48 in the mounting bracket 36 until the mounting end 46 extends through the aperture 50 and aperture 52 in the support bracket 40.

The tow hook 38 also includes a flange 56 located proximal to the towing end 44 and extending from either side of the tow hook 38. Each side of the flange 56 includes at least one slot 58, 60 that extends in the towing direction A. Bolts 62, 64 are provided to pass through the slots 58, 60 in the flange 56 and attach the flange 56 of the tow hook 38 to the mounting bracket 36 such that the mounting bracket 36 supports the towing end 44 of the tow hook 38 and the tow hook assembly 30.

A fastener 42 is attached to the mounting end 46 of the tow hook 38. The fastener 42 is configured to contact the support bracket 40 when the tow hook 38 is pulled in the towing direction A so as to resist movement of the tow hook 38 relative to the support bracket 40 in the towing direction and allow movement of the tow hook 38 in a direction opposite to the towing direction A so that the mounting end 46 moves at the angle to avoid the desired component 26. Preferably, the fastener 42 is a prevailing torque feature. For example, as shown in FIGS. 2-3, the mounting end 46 of the tow hook assembly 30 is a threaded end and the fastener 42 is a prevailing torque nut, i.e., a nut which is torqued to a specified value so as to resist self-loosening due to vibration. Alternatively, the prevailing torque feature could be a crimp nut attached to the mounting end of the tow hook, a thread-lock nut, or a threaded nut attached to the mounting end with an adhesive. Regardless of the design employed, the prevailing torque feature is preferably tuned to the specific motor vehicle to which the tow hook assembly is attached and engineered to withstand a towing direction force of at least 2 times the gross domestic weight of the motor vehicle.

In a typical installation, the towing end 44 of the tow hook assembly 30 is generally exposed beyond the front fascia 66 of the motor vehicle 10 in order to aid its use in towing. Thus, the tow hook 38 is susceptible to being impacted during collision of the motor vehicle with another object. A sufficient impact on the tow hook 38 in a direction generally opposite to the towing direction A will cause the tow hook 38 to move rearward with respect to the mounting bracket 36. With the slots 58, 60 provided in each side of the flange 56 of the tow hook 38, fasteners 62, 64 are attached to the mounting end 46 of the tow hook 38 so as to allow movement of the tow hook 38 in a direction opposite to the towing direction, the tow hook 38 is free to slide in the direction opposite to the towing direction.

Since the tow hook assembly 30, and more particular the mounting end 46, passes through the apertures 50, 52 in the support bracket 40, and has the fastener 42 on the mounting end 46 thereof and the flange 56 located proximal to the towing end, the mounting bracket 36 is capable of retaining the tow hook 38 within the mounting bracket 36 even if the tow hook 38 moves a distance sufficient enough where the slots 58, 60 of each flange 56 completely disengage from the bolts 62, 64 that secure the tow hook 38 to the mounting bracket 36. Specifically, and as shown in FIGS. 2 and 3, the tow hook 38 is retained in the mounting bracket 36 because the flange 56 and the fastener 42 are preferably dimensioned to be larger than the apertures 50, 52 in the support bracket 40. A sleeve 70 disposed is between the apertures 50 and 52 and may extend outside of the support bracket 40 through the 50 toward the towing end 44.

The mounting bracket 36 may be generally L-shaped. In this example, the mounting bracket has an arm 36A that is coupled to the mounting block 32 using the fasteners 62, 64. Of course, the mounting block 32 may be an optional component. The angle portion 36B has an aperture 80 therethrough. The aperture 80 is sized to receive the mounting end 46 therethrough while allowing the mounting end 46 to retract therein during a crash event. The arm 36C is perpendicular to arm 36A and mounts the mounting bracket 36 to the structure of the vehicle 10 such as the lateral support 20 using the fasteners 37.

The support bracket 40 is generally U-shaped and has a first portion 40A that has the aperture 50 therein, a second portion 40B and a third portion 40C. The third portion 40C that has the second aperture 52 therethrough. The sleeve 70 extends between the first portion 40A and the second portion 40C. Flanges 40D may extend outward from the respective portions 40A, 40C. In this example, the flanges 40D extend in a longitudinal direction relative to the vehicle. The strength or crash resistance of the support bracket 40 is such to allow a desired movement of the mounting end 46 during a crash. The desired direction is rearward opposite the direction of arrow 75, which corresponds to the axis of the mounting end 46. That is, the aperture 50, 52 in the first portion 40A and the third portion 40C are such to maintain the angle of the mounting end 46 during a crash.

Preferably, the force required to move the tow hook 38 in a direction opposite to the towing direction A is less than the force required to activate the airbag. Specifically, it is preferred that the tow hook assembly 30 is engineered such that the force required to move the tow hook 38 in the direction opposite the towing direction A is at least 0.5 times the gross domestic weight of the motor vehicle.

In the example above, the mounting bracket, support bracket, tow hook and fasteners are formed from materials of that allow the tow hook assembly to withstand a towing force of at least 2 times the gross domestic weight of the motor vehicle. For example, the mounting bracket and the support bracket can be stamped from a steel sheet, bent and welded into the desired shape, the tow hook can be formed from forged steel, drawn wire or cast iron, and the fastener can be milled from steel, to name a few.

Of course, one skilled in the art may readily conceive of various modifications to the above described invention. For example, a bolt adapted to shear under a predetermined shear force may be used to attach the flange of the tow hook to the support bracket. In addition, one of skill in the art would appreciate that the support bracket can be provided with the slots (although facing in a direction opposite to the towing direction), while the flange of the tow hook is provided with holes that allow the bolts to pass therethrough for securing to the slots of the support bracket.

Example embodiments are provided so that this disclosure will be thorough and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A tow hook assembly for a motor vehicle, the tow hook assembly comprising:
a mounting bracket;
a tow hook having a towing end and a mounting end, said towing end having a towing direction, the mounting end extending through the mounting bracket in a direction forming an angle not coincident with the towing direction;
a fastener attached to the mounting end of the tow hook, the fastener configured to resist movement of the tow hook relative to the mounting bracket in a towing direction and allow movement of the tow hook in a direction opposite to the towing direction; and
a support bracket comprising a first end positioned adjacent to the towing end of the tow hook and configured to support the towing end of the tow hook, said support bracket comprising a second end comprising a first portion having an aperture therethrough, and said mounting end extending through the aperture.

2. The tow hook assembly of claim 1, wherein the angle is between about 3 degrees and about six degrees from the towing direction.

3. The tow hook assembly according to claim 1, wherein the angle is 5 degrees.

4. The tow hook assembly according to claim 1 further comprising a support bracket coupled to the vehicle, said support bracket comprising apertures receiving the mounting end.

5. The tow hook assembly according to claim 4 further comprising a sleeve disposed on the mounting end, said sleeve disposed within at least one of the apertures.

6. The tow hook assembly according to claim 4 wherein the support bracket is U-shaped.

7. The tow hook assembly according to claim 4 wherein the mounting bracket comprises a first arm, a second arm disposed perpendicular to the first arm, and an angled arm disposed between the first arm and the second arm having an aperture therethrough, said aperture receiving the mounting end.

8. The tow hook assembly of claim 1, wherein the mounting bracket is configured to retain the tow hook within the mounting bracket when the tow hook moves more than a predetermined distance in the direction opposite to the towing direction.

9. The tow hook assembly of claim 1, wherein the fastener is a prevailing torque feature that is tuned to a weight of the motor vehicle.

10. The tow hook assembly of claim 1, wherein the mounting end of the tow hook is a threaded end, and the fastener is a prevailing torque nut attached to the threaded end.

11. The tow hook assembly of claim 1, wherein the tow hook is releasably attached to the mounting bracket with bolts that extends through slots in the mounting bracket.

12. The tow hook assembly of claim 1, wherein the support bracket is adapted to be mounted to a frame of the motor vehicle and the mounting bracket is adapted to be mounted to an impact beam of the motor vehicle.

13. The tow hook assembly of claim 1, wherein the tow hook comprises a flange having slots allowing movement of the tow hook in the direction opposite to the towing direction.

14. The tow hook assembly of claim 1, wherein the towing end of the tow hook is an open loop hook.
